(19) United States
(12) Patent Application Publication
(10) Pub. No.: US 2004/0139312 A1
(43) Pub. Date: Jul. 15, 2004

(54) Categorization of host security levels based on functionality implemented inside secure hardware

(75) Inventor: Alexander Medvinsky, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA

(21) Appl. No.: 10/345,075

(22) Filed: Jan. 14, 2003

(51) Int. Cl. H04L 9/00

(52) U.S. Cl. 713/150

(57) ABSTRACT

A system for rating security levels a device according to the characteristics of functions executing within secure hardware components in the device. The security level of a host is placed in a digital certificate along with a corresponding private key at the time of manufacture of a device. The digital certificate can be provided to an inquiring device so that more comprehensive system-wide security levels can be communicated and maintained. Where a network uses ticket-based key management protocols, the security rating, or level, is transferred from the certificate to an issued ticket. Inquiring devices can then check security levels of target devices by using certificates or tickets and perform transfers or grant authorizations accordingly. In a preferred embodiment a security ratings system uses six levels of security. The levels are structured to include characteristics about a device's processing. That is, the levels provide information on the amount and type of sensitive processing that can occur in non-secure (or low security) circuitry or components within a device. This gives a better indication of how prone a device is to threats that may be of particular concern in content delivery networks. Additional qualifiers can be optionally used to provide further information about a security level. For example, the degree of handling time management processing within secure hardware and whether a particular codec, watermarks or fingerprints are supported within secure hardware can each be represented by a policy qualifier.

### CROSS-REFERENCE TO RELATED APPLICATIONS

This application is related to the following co-pending U.S. patent applications which are hereby incorporated by reference as if set forth in full in this specification:

“SYSTEM FOR DIGITAL RIGHTS MANAGEMENT USING DISTRIBUTED PROVISIONING AND AUTHENTICATION,” Ser. No. ______ [TBD], filed on ______ [TBD]; and

[INCLUDE REFERENCE TO CONTENT LICENSE PATENT APPLICATION, TBD]

### BACKGROUND OF THE INVENTION

This invention is related in general to security in digital information processing systems and more specifically to communicating security levels of a device based on details of the hardware and software processing of the device.

Today's digital systems deal with many types of information, or content, used in commerce, education, entertainment, banking, government, etc. Often, such information is transferred over a digital network such as the Internet, local-area network (LAN), campus or home network, or other transfer network or scheme. Naturally, one major concern of content owners is to prevent unwanted copying, interception, transfer or other access of content by unauthorized persons.

For example, a cable television network is one popular type of digital distribution system. Owners of television programs, movies, or other content, desire to prevent users from accessing content for which they have not paid. However, preventing users from unauthorized access of specific content has become a very difficult task. This is because the large scale of the cable television network, open standards used for transmission, involvement of thousands of autonomous entities in distribution, and need to provide decryption and decoding devices locally to users in, or near, their homes prevents a unified approach to content delivery. Although a distribution channel may provide adequate security among several devices, such as within content owner's and distribution servers, at some point the content may be transferred through a device that does not provide sufficient security.

It is desirable to provide a security rating for devices so that a decision can be made as to whether to transfer content to a device. For example, if a device does not have a sufficiently high security rating then a transfer to, or through, the non-secure device will not be attempted. Another, more secure, device might be used to facilitate the transfer by re-routing through the more secure device. Other conditions may be placed on the transfer, such as requiring an end user to pay a higher price for the content if access to the content is by a device with a lower security rating.

Security rating systems exist for cryptographic modules. One such security rating system is described in the Federal Information Processing Standards (FIPS) publication 140-2, Security Requirements Available for Cryptographic Modules, May 2000 (FIPS 140-2); available, e.g., at http://csrc.ncsl.nist.gov/fips/fips140-2/fips1402.pdf. FIPS 140-2 specifies criteria that have to be met for different security level ratings 1, 2, 3 or 4, where level 1 is the lowest level of security and level 4 is the highest level. However, the FIPS 140-2 approach does not provide for securely communicating the level of security of a device to other devices. This prevents a system-wide approach for ensuring that a desired level of security for a content transfer is uniformly maintained.

Another approach to security rating is provided in extensible rights Markup Language (XrML) 2.0 Specification Part IV: Content Extension Schema, ContentGuard, Nov. 20, 2001. The XrML approach allows devices to specify, and request, desired security level ratings from different devices. A target device is given a security rating that is listed in a certificate by a certifying authority. The certificate can be provided to an inquiring device so that the inquiring device can determine whether a transfer to the target device would maintain the desired security level.

Both the ratings provided by the XrML and FIPS-140 specifications are integer values. In some applications, these ratings do not provide enough information on which to base a decision about security levels.

It is desirable to provide a system that improves upon one or more of the above, or other, shortcomings in the prior art.

### SUMMARY OF THE INVENTION

Content delivery systems may be especially prone to unauthorized accesses when decryption, decoding, or merely transfer of information are performed by software or firmware that is not executing within a secure hardware circuit. Thus, the present invention provides a system for rating security levels a device according to the characteristics of functions executing within secure hardware components in the device. The security level of a host is placed in a digital certificate along with a corresponding public key at the time of manufacture of a device. The digital certificate can be provided to an inquiring device so that more comprehensive system-wide security levels can be communicated and maintained.

Where a network uses ticket-based key management protocol, the security rating, or level, is transferred from the certificate to an issued ticket. Inquiring devices can then check security levels of target devices by using certificates or tickets and perform transfers or grant authorizations accordingly. In a preferred embodiment a security ratings system uses six levels of security. The levels are structured to include characteristics about a device's processing. That is, the levels provide information on the amount and type of sensitive processing that can occur in non-secure (or low security) circuitry or components within a device. This gives a better indication of how prone a device is to threats that may be of particular concern in content delivery networks.

A specific rating format is presented for use in a content distribution and rights-management system that includes a policies extension to an X.509 certificate provided to an inquiring device. The policies extension includes an integer value representing one of six levels, 1-6, of security levels. A level of 1 indicates the lowest level of security while a level of 6 is the highest level of security. Some of the levels are used to indicate whether certain processing is done within secure hardware modules, or not.

An additional policy qualifiers field can be optionally used to provide further information about a security level. For example, the degree of handling time management processing within secure hardware and whether a particular codec, watermarks or fingerprints are supported within secure hardware can each be represented by a policy qualifier.

In one embodiment the invention provides a method for describing the security level of a target device to an inquiring device, wherein the target device and inquiring device are coupled via a digital network. The method includes selecting an indicator that indicates the security level of the target device, wherein the indicator includes an indication of a type of processing performed in secure hardware; storing the selected indicator in a datagram; and initiating transfer of the datagram from the target device to the inquiring device.

### BRIEF DESCRIPTION OF THE DRAWINGS

FIG. 1A shows devices in an Internet Protocol Rights Management (IPRM) system;

FIG. 1B shows additional components relating to home domain access of information;

FIG. 2A illustrates transfer of content between devices; and

FIG. 2B illustrates content streaming using security level ratings.

### DETAILED DESCRIPTION OF THE INVENTION

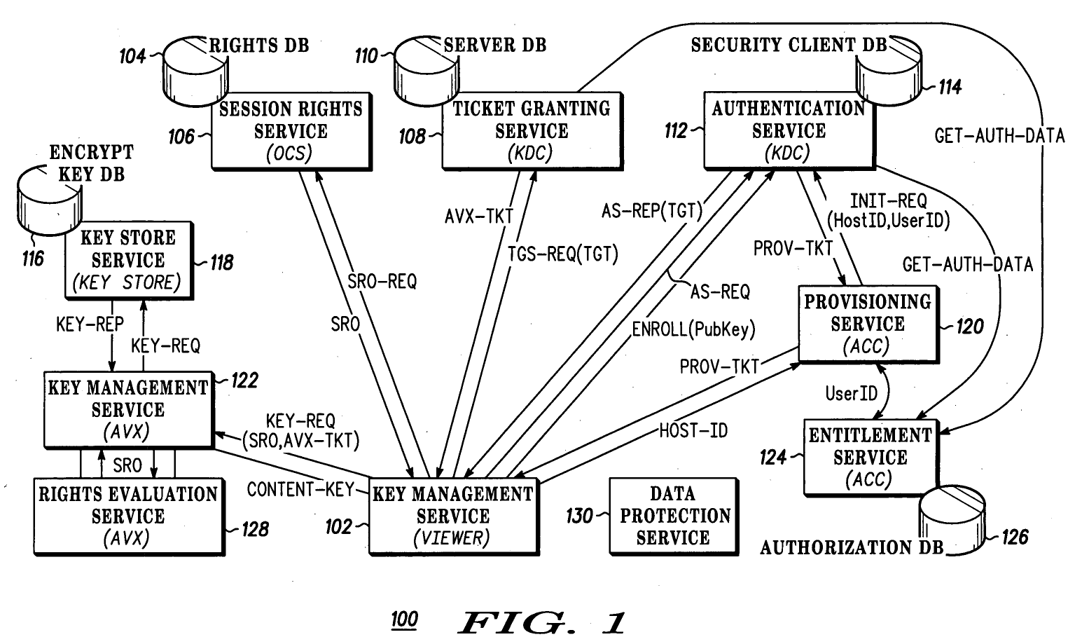

FIG. 1A shows components in an Internet Protocol Rights Management (IPRM) system suitable for use with the present invention.

In FIG. 1A, logical components are shown in boxes with an indication of the physical component that is, preferably, used to perform the functionality of the logical component in parenthesis. Note that FIG. 1A is merely a broad, general diagram of a one content distribution system. The functionality represented by logical components can vary from that shown in FIG. 1A and still remain within the scope of the invention. Logical components can be added, modified or removed from those shown in FIG. 1A. The physical components are examples of where logical components described in the diagram could be deployed. In general, aspects of the present invention can be used with any number and type of devices interconnected by a digital network.

FIG. 1A shows interfaces in the IPRM. designed for secure content distribution and for the enforcement of rights of content and service providers. Such a system is used, for example, with satellite and cable television distribution channels where standard television content, along with digital information such as files, web pages, streaming media, etc., can be provided to an end user at home via a set-top box. IPRM system 100 is illustrated using a few exemplary logical components. In an actual system, there will be many more instances of specific logical components. For example, key management service 102 is intended to execute at a user, or viewer location. Naturally, there will be millions of viewers in a typical cable television network.

The general purpose and operation of various of the entities of FIG. 1A, such as provisioning service (PS) 120, authentication service (AS) 112, entitlement service 124, client processors and other servers and devices are well-known in the art. A system such as that shown in FIG. 1A is discussed in more detail in co-pending patent application SYSTEM FOR DIGITAL RIGHTS MANAGEMENT USING DISTRIBUTED PROVISIONING AND AUTHENTICATION, referenced above. The device security ratings system of the present invention can be used among any of the components and physical and logical devices shown in FIG. 1A so that a decision can be made whether to transfer content, or other information, from an inquiring device to a target device.

FIG. 1B shows additional components relating to home domain access of information provided by a DRM system such as the IPRM system of FIG. 1A. The system of FIG. 1B can be considered as a subsystem, additional system, or overlay to that of FIG. 1A. Although FIG. 1B shows hardware devices, such devices (e.g., viewer 158) can perform portions or combinations of the functions or services described in FIG. 1A.

In FIG. 1B, viewer 158 is a display device, audio playback device, or other media presentation device, such as a television or computer. Viewer 158 is associated with local playback devices for playback of content, such as uncompressed digital media player 152, compressed digital media player 154 and analog media player 162. Such local devices are part of an “authorized domain” of equipment that is easily accessed by a user, or consumer, as illustrated by devices at 180. Note that the authorized domain can include additional networks, such as Ethernet, wireless, home phone network adapter (PNA), etc. and any number and types of devices for accessing, transferring, playing, creating, and managing content.

The authorized domain presents a special problem to security since it typically places content directly at the control of a user. As indicated in FIG. 1B, various devices may provide a user with content in various formats such as uncompressed, compressed, analog, stored, encrypted, etc. Other ways to provide content to the viewer are from remote devices such as conditional access center 150 using multicast streaming server 156 or unicast streaming server 160. Origin server 164 represents other content sources such as, e.g., a third party web site.

Information can be stored locally or remotely from the authorized domain. Sensitive information such as content decryption keys 170, encrypted content 172 and rules and metadata 174 might commonly be stored in devices that are accessible by the user. The system of the present invention can be used to improve security and rights enforcement in components and devices such as those shown in FIG. 1B.

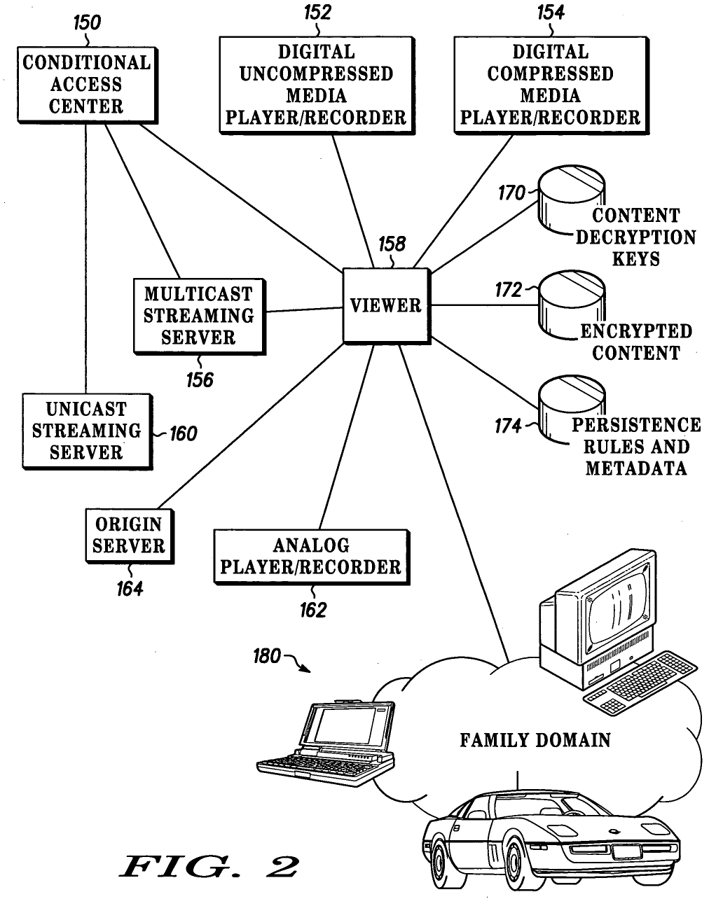

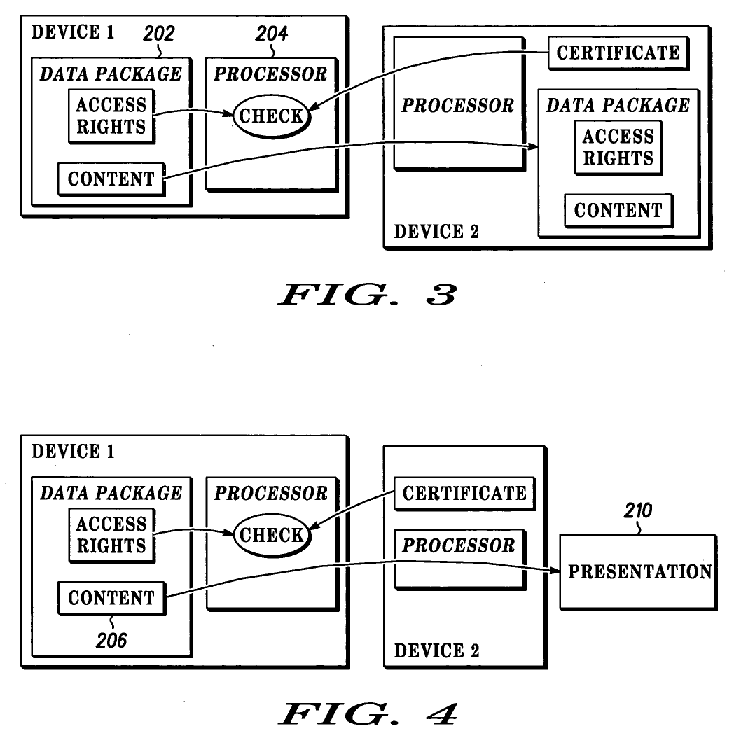

FIG. 2A illustrates transfer of content between devices.

In FIG. 2A, device 1 desires to transfer data package 202 to device 2 for later playback. Device 1 requests a digital certificate from device 2 and checks the security level in the certificate (described in more detail, below) within secure processor 204. The check compares the requirements of access rights information from data package 202. The content rights are generally stored inside a cryptographically protected object called a content license. Assuming the check shows that device 2 meets the security level requirements, the data package is then transferred by device 1 to device 2. In the example of FIG. 2A, the entire data package (i.e., contents for playback and a content license) is transferred. Although the content and content license are logically part of the same data package, they don't necessarily need to be stored in a single file or physical object. A content license for example can include content identifying information (e.g., file name) that enables the device to locate a content file that corresponds to a license. In general, it is also possible that a content license applies only to a part of a content file or alternatively a single content license may be applied to a group of several content files. This allows device 2 to make inquiries of other devices and to perform subsequent transfers of the data package.

When the content license is transferred from device 1 to device 2, it may need to be modified. For example, due to a lower level of hardware security device 2 may be granted fewer rights than device 1. Or, if a license allows content to be played back a limited number of times, device 2 may be only given one play back, while device 1 might keep the rights for the remaining play backs. Yet another reason to modify a license is that in a preferred implementation device 1 and device 2 use their own local secret (e.g., AES) key to encrypt and authenticate content licenses. Therefore, after the license is transferred to device 2 (e.g., using a secure session set up between the devices), device 2 adds a MAC (Message Authentication Code) to the license using its own secret key and also uses its own secret key to re-encrypt the license. A MAC is normally applied to the whole content license to make sure that it has not been illegally modified. Encryption, on the other hand, only needs to be applied to the secret portions of a license. For example, a content decryption key must be encrypted and kept secret from the consumer. Rights information inside the license could be stored in the clear for the convenience of the user.

Devices 1 and 2 are typically two devices within the same authorized domain and belong to the same user. These devices may or may not be connected by a network (e.g., an Ethernet). A transfer of a certificate, content and a license between the two devices can also occur in an off-line manner, e.g., via a removable disk cartridge. Therefore all communications shown on FIGS. 2A and 2B (with the exception of content presentation) could be made in both on-line and off-line manner.

Devices 1 and 2 can also belong to two different users, e.g., connected over the Internet. In this case, the content rights contained in the content license on device 1 need to indicate that such transfer of content to a different user is allowed.

Furthermore, in some cases content rights may indicate that the particular content may not be copied but can be moved. In such cases, after a copy of the content and content license is made to device 2, the copy of the content on device 1 is invalidated (e.g., the content decryption key or the whole content file is erased).

FIG. 2B illustrates content streaming using security level ratings.

In FIG. 2B, device 2 desires to receive only the content from device 1. Such an application can be, for example, a streaming media player (e.g., MP3 format audio, MPEG-4 format video, etc.). Device 1 uses its processor to perform a check on device 2's security level by requesting device 2's digital certificate. If the check is satisfactory, content 206 is sent under control of the processor in device 1 to the processor in device 2 for immediate presentation via presentation device 210.

Content rules are discussed in more detail, below, and in co-pending patent application Ser. No. ______ [TBD].

Table I, below, shows a certificate information format used in a preferred embodiment key distribution system of the invention. Although specific formats, values, variable names, data structures, and other syntactic or protocol-related terminology and organization is presented herein, it should be apparent that other embodiments can use formats that vary in number, name, type, value and other characteristics.

Table I shows the syntax of an X.509 certificate extension called certificatepolicies, as defined by RFC 3280 (Internet X.509 Public Key Infrastructure Certificate and Certificate Revocation List (CRL) Profile). The certificatePolicies extension is used in IPRM KDC client and KDC certificates and is used to indicate the level of security provided by the corresponding host.

TABLE I
certificatePolicies ::= SEQUENCE SIZE (1..MAX) OF PolicyInformation
PolicyInformation ::= SEQUENCE {

policyIdentifier CertPolicyId,
policyQualifiers SEQUENCE SIZE (1..MAX) OF PolicyQualifierInfo
OPTIONAL }

CertPolicyId ::= OBJECT IDENTIFIER
PolicyQualifierInfo ::= SEQUENCE {

| policyQualifierId PolicyQualifierId, | |
|---|---|
| qualifier | ANY DEFINED BY policyQualifierId } |

When provided in an IPRM digital certificate, the CertPolicyID has a value, OBJECT IDENTIFIER (OID), corresponding to a security level as shown in Table II.

TABLE II

| Security | | Symbolic | |
|---|---|---|---|
| Level | OID | Name | Description |
| 1 | IPRMSecurityLevel.1 | None | No hardware or software-level |
| | | | protection provided for either the |
| | | | keys or the DRM software. |
| 2 | IPRMSecurityLevel.2 | SW | Tamperproof software techniques are |
| | | | used to obfuscate the keys and make |
| | | | it difficult to hack the software. |
| 3 | IPRMSecurityLevel.3 | HWPubKey | All client-side private keys (used for |
| | | | public key cryptography) are stored |
| | | | and accessed inside the hardware |
| | | | module. This includes the client |
| | | | private authentication key. It also |
| | | | includes Diffie-Hellman key pair |
| | | | generation and signing of the Diffie- |
| | | | Hellman public value inside the |
| | | | hardware module. |
| 4 | IPRMSecurityLevel.4 | HWKeyMgmt | All DRM-related key management is |
| | | | implemented inside the secure |
| | | | hardware module. Content |
| | | | decryption or authentication keys are |
| | | | not protected by the secure hardware |
| | | | module. |
| 5 | IPRMSecurityLevel.5 | HWAllKeys | All cryptographic keys are stored |
| | | | inside a secure hardware module and |
| | | | all cryptographic operations |
| | | | associated with these keys are also |
| | | | implemented inside the same module. |
| 6 | IPRMSecurityLevel.6 | HWFullDRM | Same as HWAllKeys and in addition |
| | | | the content rights are evaluated inside |
| | | | the secure hardware module. Time |
| | | | based restrictions and content |
| | | | expiration are also enforced by the |
| | | | hardware module if it must process |
| | | | secure time. Remaining content rules |
| | | | are evaluated inside the hardware |
| | | | module but the outcome of the |
| | | | evaluation may be provided to host |
| | | | processor software which would be |
| | | | responsible for enforcing those rules. |

The OID “IPRMSecurityLevel.1” indicates that no hardware or software-level protection is provided for either keys or digital rights management (DRM) software in a specific device. In other words, this is the lowest level of protection within the six-level rating system. In the case when a device does not possess an X.509 certificate or has a certificate that does not specify the device security level, the device is implicitly assumed to have the host security rating IPRMSecurityLevel.1. Preferably, each device is provided with an Object Identifier (OID) that gives unique identification within ASN.1 formatted objects such as X.509 certificates and tickets. For example, an X.509 certificate at the time of manufacture that can later be authenticated within a DRM system. Alternative approaches can use certificates that are issued after manufacture of a device, for example, at a repair facility when device hardware and software are being upgraded. With this latter approach, a device's security level can also change if properties of the device change. A device security level can also be provided in tickets, as discussed below.

A security level with an OID value of IPRMSecurityLevel.2, indicates that tamperproof software techniques are used within the device to obfuscate the keys and make it difficult to hack the software. For example, encoded or dispersed storage of the key data, self-modifying code, or other techniques can be used to make it difficult for someone to decompile, disassemble, or otherwise detect the presence and value of the keys.

Security level with an OID value of IPRMSecurityLevel.3 indicates that all client-side private keys (used for public key cryptography) are stored and accessed inside a hardware module. This can include client private authentication keys, Diffie-Hellman key pair generation and signing of a Diffie-Hellman public value inside the hardware module. Within a non-IPRM system, this security level could also mean that private keys used for encryption are stored within a hardware module.

Security level with an OID value of IPRMSecurityLevel.4 indicates that all DRM-related key management is implemented inside a secure hardware module. This security level also means that content decryption or authentication keys are not be protected by the secure hardware module.

Security level with an OID value of IPRMSecurityLevel.5 indicates that all cryptographic keys are stored inside a secure hardware module and all cryptographic operations associated with these keys are also implemented inside a secure hardware module. One or more hardware modules can be used, as long as a cryptographically secure (encrypted and authenticated) interface is implemented between the multiple hardware modules.

Security level with an OID value of IPRMSecurityLevel.6 is similar to IPRMSecurityLevel.5 but additionally indicates that content rights are evaluated inside a secure hardware module. If the module processes secure time, then the hardware module also enforces time-based restrictions and content expirations. Any other types of rights or rules not discussed herein can, optionally, be evaluated either inside (preferably) or outside of a secure hardware module. The outcome of the evaluation can be provided to host processor software responsible for enforcing those rules.

Some examples of such rules include restrictions on analog output derived from the protected digital data. For example, (1) no analog output allowed, (2) analog output is allowed but only with copy-protection measures (e.g., Macrovision) enabled, (3) limiting the pause buffer size, etc. For these examples, it is desirable that devices enforcing rules on analog output also be able to control the use of analog output ports, pause buffers, etc. Putting analog ports and content playback software inside a security chip is typically a problem because different devices, or even different models of the same type of device, have different hardware configurations. This means that a new, custom security chip is needed for each new device—which is impractical.

Therefore, a reasonable compromise for a DRM implementation is to use the security chip to enforce time-based expiration of content or expiration of corresponding content decryption keys, while other content rules are evaluated less securely outside of the security chip in order to keep the security chip design generic.

The security level values and meanings used in the preferred embodiment can be varied in different embodiments. More or less levels of indication can be provided. In future embodiments it may be possible to change the meaning of security levels within a device, or among devices in a network. Device ratings can be updated, accordingly.

The ratings scheme of the preferred embodiment also provides for optional extensions. Table III shows PolicyQualifierID values and meanings that can be used to provide further information about security levels 5 and 6 (IPRMSecurityLevel.5 and IPRMSecurityLevel.6, respectively).

TABLE III

| Policy | | |
|---|---|---|
| QualifierlD | Description | Qualifier |
| IPRMSecureTime | Time management is | None |
| | implemented inside secure | |
| | hardware. This includes | |
| | ESBroker secure time | |
| | protocol as well as an | |
| | oscillator inside the secure | |
| | hardware. This parameter | |
| | applies to security level 6 | |
| | only. | |
| IPRMCodecsInHardware | AAC audio codec | None |
| aac(1) | | |
| IPRMCodecsInHardware | MPEG-2 | Mp2Qualifier ::= |

| mp2(2) | SEQUENCE OF |
|---|---|
| | MpProfile |
| | MpProfile ::= SEQUENCE |
| | { |

profile INTEGER,
maxLevel INTEGER

| | | } |
|---|---|---|
| IPRMCodecsInHardware | MPEG-3 | None |
| mp3(3) | | |
| IPRMCodecsInHardware | MPEG-4 | Mp4Qualifier ::= |

| mp4(4) | SEQUENCE OF MpPart |
|---|---|
| | MpPart::= SEQUENCE { |

part INTEGER,

// possible values

are

// 2 or 10

profiles SEQUENCE

OF MpProfile
}
MpProfile ::= SEQUENCE
{

profile INTEGER,
maxLevel INTEGER

}

In Table III the policy qualifier, “IPRMSecureTime”, when present, indicates that the device processes secure time in hardware. Therefore, such a device can invalidate expired rental content more securely. A content provider could mandate in a content license that particular rented content be stored only on devices that process secure time inside a cryptographic hardware module.

Other entries in the above table specify that various content decompression algorithms are implemented inside an integrated cryptographic hardware module. An important goal of Digital Rights Management is to avoid exposing any part of the compressed content in the clear outside some physically protected environment—because compressed content is considered to be of higher quality and is more compact to store than uncompressed digital content. When a decompression algorithm is implemented inside a cryptographic module, this DRM goal is achieved—if it is implemented in software, this goal cannot be met. Based on the capabilities of performing decompression in secure hardware, content can be withheld or not withheld from a particular device.

Security level 6 can include policy qualifiers that indicate a list of watermarks and/or fingerprints that are supported in secure hardware. A preferred embodiment reserves OID values for this purpose. Similar to the capabilities to perform content decompression, a device is more secure if watermark detection or fingerprinting (watermark insertion) can be performed inside a secure cryptographic module. Watermarked content or content that has to be fingerprinted upon reception can be withheld, or not withheld, from a device depending on the corresponding capabilities to perform watermarking or fingerprinting inside secure hardware.

It is acceptable to have multiple policy qualifiers with the same ID in the same certificate because each one could correspond to a different profile for the same codec, watermark or fingerprint. For example, the Mpeg-4 codec could be listed twice—once specifying part 2 basic profile and the second time specifying part 10 basic profile (as defined in the MPEG-4 standards, see, e.g., H.264).

Table IV, below, shows additional qualifiers that can be used in content rules. These rules are described in more detail in the co-pending patent application referenced, above.

TABLE IV

| Attribute | Description | Required |
|---|---|---|
| SecurityLevelToRender | This is the minimum required security level of a | No |
| | client for rendering content. It is used by a home | |
| | gateway device to determine if another home network | |
| | device is authorized for content re-distributed on a | |
| | home network. | |
| SecurityLevelToCopy | This is the minimum required security level of a | No |
| | client for storing a copy of some content. It is used | |
| | by a home gateway device to determine if another | |
| | home network device is authorized for storing its | |
| | own copy of the content available from the home | |
| | gateway. | |
| CodecInSecureHW | If this flag is TRUE (1), this content may only be | No |
| | consumed when decompression is performed inside | |
| | secure hardware. This flag should only be set when | |
| | SecurityLevelToRender is set to HWFullDRM or | |
| | HWAllKeys. | |
| WatermarkInSecureHW | If this flag is TRUE (1), this content may only be | No |
| | consumed when watermark detection is performed | |
| | inside secure hardware. This flag should only be set | |
| | when SecurityLevelToRender is set to HWFullDRM | |
| | or HWAllKeys. | |
| FingerprintInSecureHW | If this flag is TRUE (1), this content may only be | No |
| | consumed when fingerprint generation is performed | |
| | inside secure hardware. This flag should only be set | |
| | when SecurityLevelToCopy is set to HWFullDRM or | |
| | HWAllKeys. | |
| Fingerpint | Defines a fingerprint and its associated parameters to | No |
| | be applied to received content. | |

One aspect of the present invention provides for security ratings to be included in a ticket, or other record or data used to assist a device, process or other entity to authenticate another entity or service. The ticket includes the client's (e.g., device's) identity, a session key, timestamp and other information all sealed using a server's secret key. The format of the ticket in a preferred embodiment is shown Table V, below.

TABLE V

| Attributes | Description |
|---|---|
| TktVnum | This field specifies the version number |
| | for the ticket format. Must be set to 1 for this version. |
| Realm | This field specifies the realm part of the |
| | server's identity. |
| Sname | This field specifies the name part of the |
| | server's identity. |
| AuthTime | This field indicates the time at which |
| | the ticket was initially created. |
| EndTime | This field indicates the expiration time |
| | of the ticket, after which it is no longer Valid. |
| EncryptedData | This part contains client's identity, |
| | session key and other authorization data encrypted |
| | with server's secret key (service key). The attribute |
| | being encrypted is of type PrivateTicketPart. It is |
| | encrypted with a service key known only to the KDC |
| | and to the specified application server. |
| SkeyVnum | Version number of the service key |
| | (used to encrypt the private part of the ticket). |
| EncTypeSet | Server Supported Encryption Types. |
| CsumTypeSet | Server Supported Checksum types. |
| SecurityLevel | This is an optional field that specifies |
| | the security level of the client, i.e., the level of local |
| | software or hardware protection that prevents hacking, |
| | secret key extraction, etc. hi the case this field is not |
| | present, the lowest security level (=1) is assumed. See |
| | tables II and III for details on different security levels |
| | and optional parameters associated with security levels |
| | 5 and 6. |
| Signature | A checksum over the ticket, keyed with |
| | server's secret key (service key). |

Tickets can use the format defined by, e.g., Kerberos version V as defined by RFC 1510, or other suitable formats. In a Kerberos-type ticket, security levels can be placed in a standard field called “authorization data.”

Although the invention has been described with reference to specific embodiments, these embodiments are merely illustrative, and not restrictive, of the invention. For example, mechanisms other than certificates and tickets can be used to indicate a security level. For example, in some cases, especially where a device's security level is low, it may not be necessary to protect or certify the security rating being communicated. Security ratings can be kept by a trusted third party and an inquiring device can obtain the rating from the third party. Encrypted lists of devices and associated ratings can be distributed to other devices on a network. Other approaches are possible.

Security levels can be transferred from a certificate to a ticket and vice versa. Other forms of indicating security levels can be employed. For example, simple encryption of a message indicating a security level can be used. Security levels can also be transmitted unencrypted, as clear text, if the transmission link is known to be secure.

In general, the functionality of the present invention discussed herein can be performed in hardware, software or a combination of both. Multiple processors can be used in parallel, concurrent, distributed, etc. types of processing. Functionality can be performed at different times, in different sequences, or by one or more different devices than those presented herein. Locations where functions are executed or performed can vary from those discussed herein. In other words, although a function may be described as occurring at a specific device, other embodiments may have that function occurring at a different device, or devices, or location(s). Although the Internet, or other specific digital network arrangements (e.g., client-server), and protocols (e.g., Internet Protocol), have been discussed, any type of network and network devices can benefit from aspects of the present invention.

Any degree of indication can be used to represent a security level. For example, rather than have discrete levels, a continuous numbering system can be used. Indications can be coarser or broader than those described herein. The evaluation of the security level can apply both on the initial transfer of content from a content provider to a consumer, as well as during the transfer of content between multiple devices that belong to that same consumer or to other parties or business entities. When the content is transferred between multiple devices belonging to the same consumer, from device A to device B, device A needs to consult a content license to determine of the security level of device B is sufficient in order to provide it with the requested content. The security level check can also be performed by device A after it already transferred encrypted content to B—as long as A has not yet provided the corresponding decryption key to B.

Aspects of the present invention can apply to devices that are not coupled by a digital network. For example, transferring content on a CD or DVD to another device for recording or presentation can be done in analog form. A datagram including a security rating can be transferred manually in a storage device such as a memory stick, smart media card, portable computer, etc.

Obtaining security levels can be from an inquiring device to a target device. Or the receiving device (i.e., destination of a content transfer) may initiate a request and offer to supply the sending device with the security level of the receiving device. Or a third device, such as a server, can be consulted for device security levels. A third device can even initiate or facilitate a transfer between the sending and receiving devices and can play a role in checking the security levels of one or more devices.

Thus, the scope of the invention is to be determined solely by the appended claims.

What is claimed is:

1. A method for describing the security level of a target device to an inquiring device, wherein the target device and inquiring device are coupled via a digital network, the method comprising
selecting an indicator that indicates the security level of the target device, wherein the indicator includes an indication of a type of processing performed in secure hardware;
storing the selected indicator in a datagram; and
initiating transfer of the datagram from the target device to the inquiring device.

2. The method of claim 1, wherein the indicator is stored in the target device at the time of manufacture.

3. The method of claim 1, wherein the target device includes one or more cryptographic keys, wherein the indicator includes an indication that software techniques are used to obfuscate the keys.

4. The method of claim 1, wherein the target device includes one or more cryptographic keys, wherein the indicator includes an indication of the degree that keys are accessed within a secure hardware module.

5. The method of claim 1, wherein the indicator includes an indication of the degree to which digital rights management processing is performed within a secure hardware module.

6. The method of claim 1, wherein the indicator includes an indication of the degree to which time management is performed within a secure hardware module.

7. The method of claim 1, wherein the indicator includes an indication of the degree to which time management is performed within a secure hardware module.

8. The method of claim 1, wherein the indicator includes an indication of the degree to which a codec is supported within a secure hardware module.

9. The method of claim 1, wherein the indicator includes an indication of the degree to which a digital watermark is supported within a secure hardware module.

10. The method of claim 1, wherein the indicator includes an indication of the degree to which a digital fingerprint is supported within a secure hardware module.

11. The method of claim 1, wherein the datagram is included in one or more packets.

12. The method of claim 1, wherein a digital certificate is provided with the indicator.

13. The method of claim 1, wherein the datagram includes a digital certificate.

14. The method of claim 13, wherein the indicator is transferred from the digital certificate to a ticket.

15. The method of claim 1, wherein the datagram includes a ticket.

16. The method of claim 15, wherein the indicator is transferred from the ticket to a digital certificate.

17. An apparatus for providing the security level of a device, the apparatus comprising
a stored indicator that indicates the security level of the device, wherein the indicator includes an indication of a type of processing performed in secure hardware within the device;
a coupling for coupling the device to a digital network; and
a processor for transferring the stored indicator to the digital network.

18. A method for describing the security level of a target device to an inquiring device, the method comprising
evaluating an indicator that indicates the security level of the target device, wherein the indicator includes an indication of a type of processing performed in secure hardware in the target device.

19. The method of claim 18, further comprising
transferring the indicator over a digital network.

20. The method of claim 18, further comprising
transferring the indicator by using a storage device.

21. The method of claim 18, wherein a device includes a compact disk player.

22. The method of claim 18, wherein a device includes a digital versatile disk player.

23. The method of claim 18, wherein a device includes an audio playback device.
